(19) United States
(12) Patent Application Publication
(10) Pub. No.: US 2026/0036424 A1
(43) Pub. Date: Feb. 5, 2026

(54) Method for Distance Ranging Combining Time of Flight Sensor with Aiming Dot Parallax Detection

(71) Applicant: ZEBRA TECHNOLOGIES CORPORATION, Lincolnshire, IL (US)

(72) Inventors: Justin F. Barish, Kings Park, NY (US); Matthew Lawrence Horner, Sound Beach, NY (US); Thomas L. Pyle, Centerreach, NY (US)

(21) Appl. No.: 18/791,373

(22) Filed: Jul. 31, 2024

(51) Int. Cl. G01C 3/10; G01B 11/22; G01S 7/4865; G01S 17/10

(52) U.S. Cl. CPC G01C 3/10; G01B 11/22; G01S 7/4865; G01S 17/10

(57) ABSTRACT

Imaging devices, systems, and methods for capturing and processing images, by using multiple distance determinations to set the focal position of variable-focus lens are provided. Imaging devices include a low-resourced depth sensor detecting an object distance over a first field of view (FOV). The imaging devices include an imaging sensor determining an object distance over a second FOV using parallax detection of an aiming pattern. Processors are configured to compare the two distances and, in response, to discordance perform a series of mitigations to determine a desired distance. The variable-focus lens is then set to that desired distance for subsequent image capture and indicia analysis.

### BACKGROUND

Imaging devices, such as barcode readers or other handheld indicia reader, may determine the distance between the imaging device and a target object, such as an object having a barcode. The imaging devices may use this distance to set a focus position of a variable-focus imaging assembly for capturing in-focus images of the barcode, and then using those in-focus images for identification and decoding of a barcode.

There are numerous techniques by which an imaging device can measure the distance of an object. For example, some imaging devices project an aiming dot pattern onto the object and measure an aiming dot pattern shift, e.g., a parallax shift from which an object distance is calculated. However, these techniques often fail due to specular reflection (e.g., when the object has a shiny surface), glancing angles (e.g. attempting to scan a shiny label at a sharp angle), bright light (e.g., imaging in an outdoor environment), hand jitter, or when the aiming dot passes through the object (e.g., shooting through holes in the object as commonly occurs when trying to scan a barcode on a milk crate).

While other forms of measuring distance exist, such as using a time of flight (ToF) sensor, these techniques are insufficient for scanning applications, as they often require high power, large physical size, and/or large cost. Plus, these other techniques cannot measure distances as far as the scan engine requires.

Contributing to the deficiencies of these techniques, the failure to measure object distance can cause prolonged decode times that are unacceptable to the customer. There is a need for techniques to determine the distance to an object, especially when using imaging devices having with variable-focus imagining assemblies, and to make such determinations without relying upon processing intensive components but while maintain fast operation to allow for the scanning objects and/or indicia in a fast, accurate manner.

### SUMMARY

In an embodiment, an imaging device for capturing and processing images is provided. The imaging device includes a housing and a depth sensor operable to detect that an object is in a ranging field of view (FOV) of the depth sensor. The imaging device further includes an imaging sensor at least partially disposed within the housing and operable to capture images of the object within an imaging FOV of the imaging sensor. The imaging device further includes one or more processors and a computer-readable media storing machine readable instructions that, when executed, cause the one or more processors to: detect, using the depth sensor, a first detected distance of the object from the imaging device; perform, using the imaging sensor, a distance ranging procedure to detect a second detected distance of the object from the imaging device; and compare the first detected distance to the second detected distance. The machine readable instructions further cause the one or more processors to, in response to a difference between the first detected distance and the second detected distance, perform a mitigation to determine a desired distance to the object.

In a variation of this embodiment, the depth sensor is a time of flight (TOF) sensor.

In another variation of this embodiment, the imaging device further comprises: an aimer assembly operable to generate an aiming pattern in the imaging FOV; and wherein the computer-readable media stores machine readable instructions that, when executed, cause the one or more processors to: perform, using the imaging sensor, the distance ranging procedure to detect the second detected distance by performing an aiming pattern parallax detection in the imaging FOV.

In yet another variation of this embodiment, the depth sensor is operable to detect the object within a predetermined distance range from the imaging device, wherein the imaging sensor is operable to image the object over a range larger than the predetermined distance range.

In yet another variation of this embodiment, the computer-readable media stores machine readable instructions that, when executed, cause the one or more processors to: detect, using the depth sensor, the first detected distance of the object from the imaging device when the object is within a predetermined range from the imaging device; and perform, using the imaging sensor, the distance ranging procedure over a range larger than the predetermined distance range.

In yet another variation of this embodiment, the mitigation comprises: (i) in response to the first detected distance being shorter than the second detected distance, perform the distance ranging procedure again using the first detected distance as a reference to detect a corrected second detected distance; and (ii) in response to the first detected distance being further than the second detected distance, set the desired distance to the object as the second detected distance.

In yet another variation of this embodiment, the depth sensor comprises multiple zones and is operable to detect a different first detected distance of the object from the imaging device for each zone.

In yet another variation of this embodiment, the computer-readable media stores machine readable instructions that, when executed, cause the one or more processors to: detect, using the depth sensor, the first detected distance of the object from the imaging device as an average of the different first detected distances of the multiple zones or a median of the different first detected distances of the multiple zones.

In yet another variation of this embodiment, the mitigation comprises: (i) in response to the first detected distance being further than the second detected distance, determine if a minimum of the different first detected distances is within an accepted range of the second detected distance; and (ii) if the minimum of the different first detected distances is within the accepted range of the second detected distance, set the desired distance to the object as the second detected distance otherwise set the desired distance to the object as the average of the different first detected distances of the multiple zones.

In yet another variation of this embodiment, the computer-readable media stores machine readable instructions that, when executed, cause the one or more processors to: in response to the depth sensor failing to detect the first detected distance of the object, set the desired distance to the object as the second detected distance.

In yet another variation of this embodiment, the computer-readable media stores machine readable instructions that, when executed, cause the one or more processors to: in response to the imaging sensor failing to detect the second detected distance of the object, set the desired distance to the object as the first detected distance.

In yet another variation of this embodiment, the computer-readable media stores machine readable instructions that, when executed, cause the one or more processors to: in response to (i) the imaging sensor failing to detect the second detected distance of the object and (ii) the depth sensor failing to detect the first detected distance of the object, instructing the imaging sensor to perform a focus ramping procedure.

In yet another variation of this embodiment, a ratio of the size of a pixel array of the depth sensor to a pixel array of the imaging sensor is 1 to 100 or greater.

In yet another variation of this embodiment, the ratio of the size of the pixel array of the depth sensor to the pixel array of the imaging sensor is 1 to 200 or greater.

In yet another variation of this embodiment, the depth sensor is operable to detect the first detected distance over a first plurality of binned distance ranges and wherein the imaging sensor is operable to performing the distance ranging procedure over a second plurality of binned distance ranges, wherein at least some of the first plurality of binned distance ranges overlap with the second plurality of binned distance ranges.

In another embodiment, a method is provided for capturing and processing images using an imaging device. The method includes detecting, using a depth sensor of the imaging device, a first detected distance of an object within a ranging field of view (FOV), the first detected distance being between the object and the imaging device. The method further includes generating, using an aiming assembly, an aiming pattern in an imaging FOV of an imaging sensor. The method further includes performing, using the imaging sensor, a distance ranging procedure analyzing the aiming pattern in the imaging FOV and detecting a second detected distance of the object from the imaging device. The method further includes comparing the first detected distance to the second detected distance and in response to a difference between the first detected distance and the second detected distance performing a mitigation to determine a desired distance to the object. In response, the method adjusts a variable-focus lens assembly of the imaging device to a focal distance based on the desired distance.

In a variation of this embodiment, the depth sensor is a time of flight (TOF) sensor, and the distance ranging procedure is an aiming pattern parallax detection procedure.

In another variation of this embodiment, detecting the first detected distance of the object within the ranging field of view (FOV) is performed over a predetermined depth sensor distance range, and detecting second detected distance of the object from the imaging device is performed over a predetermined imaging sensor distance range, wherein the predetermined imaging sensor distance range is larger than the predetermined depth sensor distance range.

In yet another variation of this embodiment, performing the mitigation comprises: in response to the first detected distance being shorter than the second detected distance, performing the distance ranging procedure again using the first detected distance as a reference to detect a corrected second detected distance; and in response to the first detected distance being further than the second detected distance, setting the desired distance to the object as the second detected distance.

In yet another variation of this embodiment, the depth sensor comprises multiple zones and is operable to detect a different first detected distance of the object from the imaging device for each zone, and detecting the first detected distance of the object comprises: setting the first detected distance of the object from the imaging device as an average of different first detected distances of the multiple zones or as a median of the different first detected distances of the multiple zones.

In yet another variation of this embodiment, performing the mitigation comprises: in response to the first detected distance being further than the second detected distance, determining if a minimum number of the different first detected distances is within an accepted range of the second detected distance; and if the minimum number of the different first detected distances is within the accepted range of the second detected distance, setting the desired distance to the object as the second detected distance otherwise setting the desired distance to the object as the average of the different first detected distances of the multiple zones.

In yet another variation of this embodiment, performing the mitigation comprises: in response to the depth sensor failing to detect the first detected distance of the object, setting the desired distance to the object as the second detected distance.

In yet another variation of this embodiment, performing the mitigation comprises: in response to the imaging sensor failing to detect the second detected distance of the object, setting the desired distance to the object as the first detected distance.

In yet another variation of this embodiment, performing the mitigation comprises: in response to (i) the imaging sensor failing to detect the second detected distance of the object and (ii) the depth sensor failing to detect the first detected distance of the object, instructing the imaging sensor to perform a focus ramping procedure.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A illustrates a perspective view of a first example imaging device, in the form of a handheld barcode reader;

FIG. 1B illustrates a side view of the imaging device of FIG. 1A;

FIG. 1C illustrates a top view of the imaging device of FIG. 1A;

FIG. 2A illustrates a block diagram of an example implementation of the imaging device of FIG. 1A;

FIG. 2B illustrates a block diagram of an example implementation of the imaging device of FIG. 1A performing a time-of-flight distance measurement and an aiming pattern parallax detection distance measurement;

FIG. 2C illustrates a comparison of an example depth sensor for performing a time-of-flight distance measurement and of an example imager for performing an aiming pattern parallax detection distance measurement;

FIG. 3 illustrates a flow diagram of an example method for capturing and processing images of an object through determining the object distance to an imaging device;

FIG. 4 illustrates a flow diagram of an example method for performing a mitigation as may be performed by the method of FIG. 3.

FIG. 5 illustrates a flow diagram of another example method for performing a mitigation as may be performed by the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Operating a variable-focus imaging assembly of an indicia reader, or other imaging device, while it is outside a threshold distance range may result in the execution of focus operation (e.g., ranging operations, image capture operations) that waste time, energy and/or resources of the indicia reader and/or the user of the indicia reader. Therefore, it is an objective of the present disclosure to provide an imaging device having an indicia reader, with a variable-focus imagining assembly, that relies upon multiple systems to determine the distance to an object and that uses algorithms to compare results of those systems and resolve discordant results in a manner that achieves fast scanning operation of an object, an indicia, etc.

In particular, in various examples, the techniques here describe an imaging device having a housing, a depth sensor operable to detect that an object is in a ranging field of view (FOV), and an imaging sensor operable to capture images of the object within an imaging FOV of the imaging sensor. The imaging device further includes one or more processors configured to detect, using the depth sensor, a first detected distance of the object and perform, using the imaging sensor, a distance ranging procedure to detect a second detected distance of the object. The one or more processors compare the first and second detected distances and, in response to a difference therebetween (termed herein a discordance), instruct the imaging device to perform a mitigation that determines a desired distance to the object.

In various examples, imaging devices and methods herein utilize a depth sensor in the form of a time of flight (TOF) sensor emitting light towards an object in a first FOV. In various examples, that depth sensor is used in combination with parallax-based distance ranging, for example, using an imaging sensor configured to determine the object distance in a second FOV. The imaging devices may be configured with processing algorithms that blend results of each modality to produce fast, highly accurate, low-resourced distance ranging. By blending TOF distance ranging with parallax-based distance ranging, short-range TOF sensors can be used without decreasing the imaging range (e.g., the range for accurately scanning an indicia) of the imaging device.

With the present techniques, an imaging device with a variable-focus imaging assembly, conventionally thought to be a slower device, can now achieve performance speeds like those of fixed focus scan engines when scanning objects at close ranges. This is not possible using conventional methods. Further, with the present techniques, the processing algorithms can have tailored configurations. This way discordant distance values can be resolved quickly, advantageously allowing optimizing focal distance settings for the variable-focus lens assembly.

The depth sensor may determine an object's distance emitting light towards an object in its FOV. The object then reflects the light back toward the depth sensor (e.g., following a substantially similar path), which receives the reflected light and determines the time the light spent traveling between the handheld barcode reader and the object (e.g., TOF value). Based on such a TOF value, the imaging sensor may then calculate the distance between the handheld barcode reader and the item.

With the present techniques, imagining devices are able to compare the readings from a depth sensor-based distance ranging and a separate parallax-based distance ranging and resolve discordant values to quickly and accurately determine a distance of an object and then set the variable-focus imagining assembly at the appropriate focusing distance to begin capturing images for use in scanning an indicia. While various examples are described in the context of scanning an indicia, the present techniques may also be used to determine and set focusing distance of imaging devices used in machine vision applications, such as detecting activity from bad-faith actors (e.g., ticket switching, sweethearting, scan avoidance, etc.), recognizing objects without traditional scanning indicia (e.g., produce recognition), general object recognition (e.g., for comparison to an identity determined by decoding a barcode or other indicia), training a machine learning model to perform such tasks, and any other similar such machine vision application.

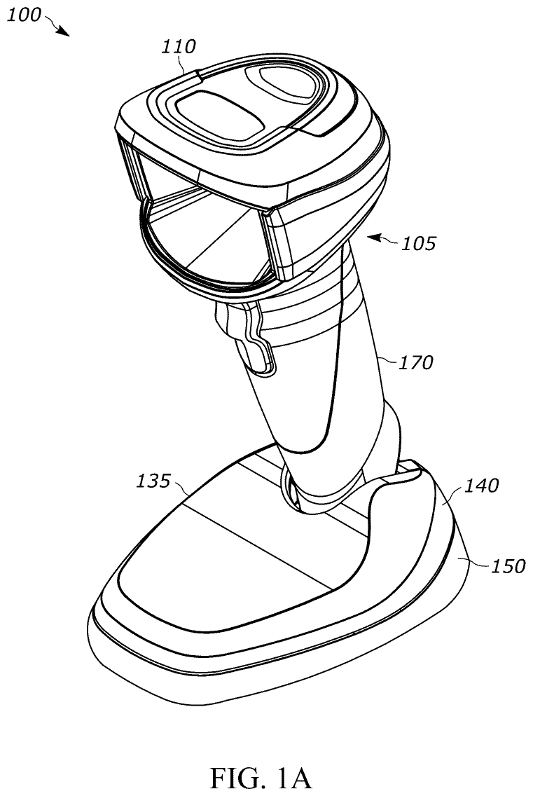

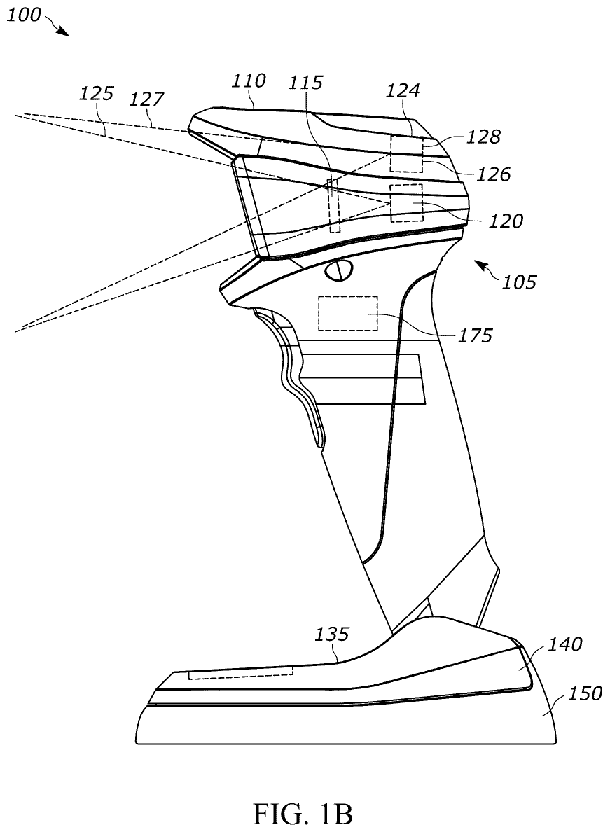

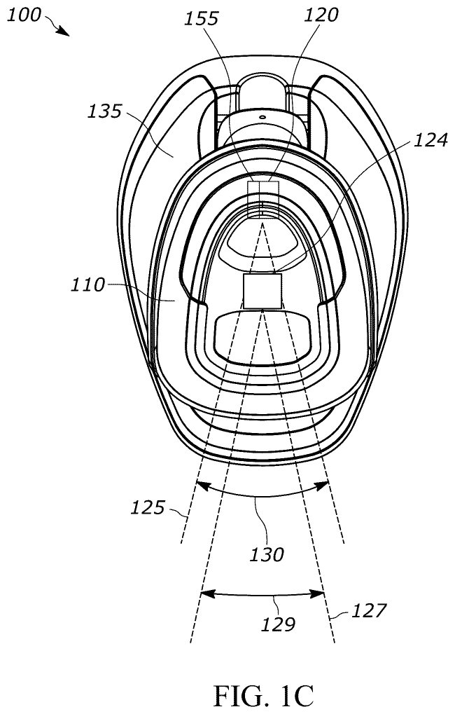

Referring to FIGS. 1A-1C, a first example imaging device 100 is illustrated. The imaging device 100, a handheld indicia reader in this example, includes a housing 105 having a head portion 110 and a base portion 135. While lower portion 150 is shown as being separable from upper portion 140 in a horizontal direction, the separation between lower portion 150 and upper portion 140 could be vertical or in any other direction appropriate for a particular application. In the particular example shown, housing 105 also has a handle portion 170 positioned between head portion 110 and base portion 135 and configured to be grasped by the hand of a user.

An imaging assembly 120 is positioned at least partially in head portion 110 and has an imaging FOV 125 that is directed through a scan window 115 in head portion 110. The imaging assembly 120 includes a variable-focus imaging assembly, for example, a variable-focus lens having a focal distance that is controllable through electric, mechanical, thermal, or other means. In various examples, the imaging assembly 120 may be a barcode reading module.

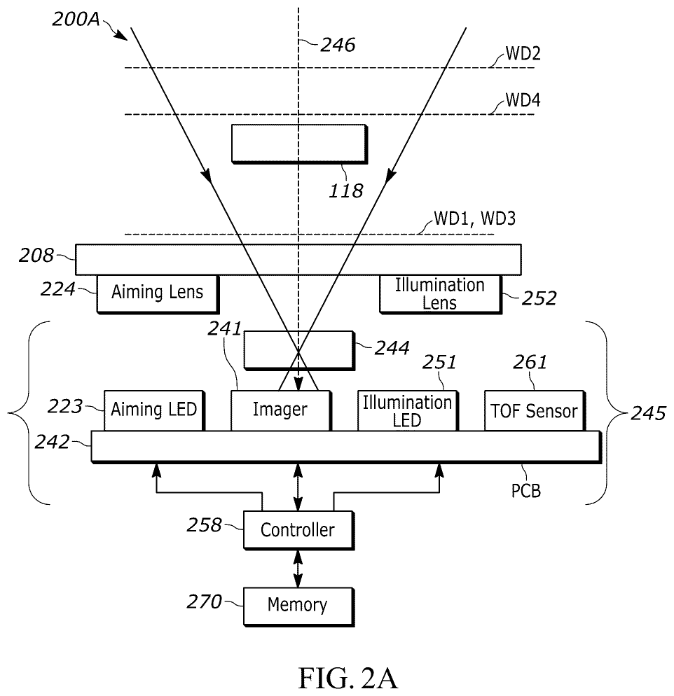

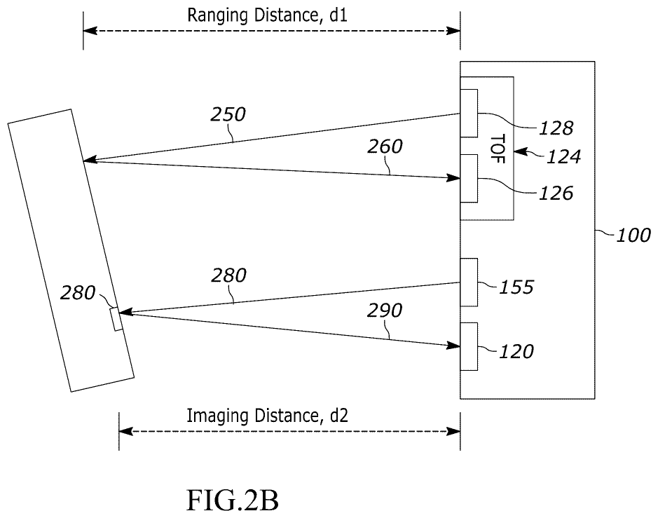

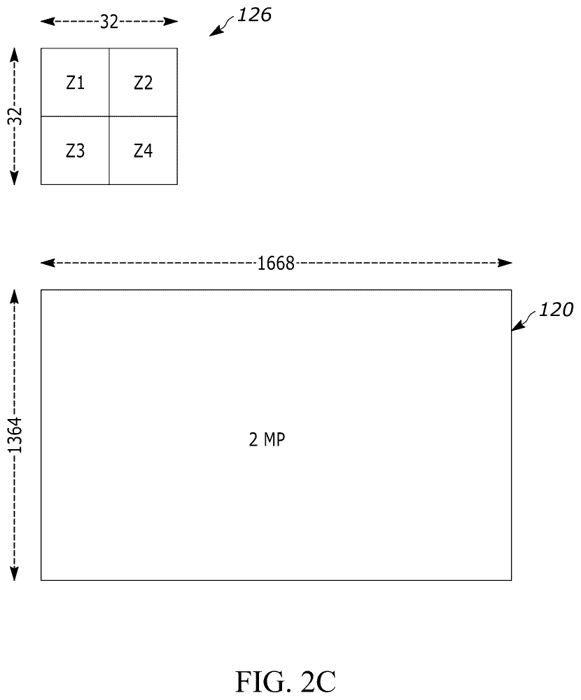

The imaging device 100 further includes a depth sensor device 124 similarly positioned at least partially in head portion 110 and has a depth FOV 127 that may similarly be directed through the scan window 115. In some examples, the depth FOV 127 at least partially overlaps the imaging FOV 125. In some examples, the depth sensor device 124 includes an illumination light source 128 and one or more sensors 126, the functionality of which is described in more detail with regard to FIG. 2B below. Depending on the implementation, the depth sensor device 124 may instead be positioned on top of the head portion 110, below the head portion 110, in the base portion 135, on top of the base portion 135, and/or otherwise exterior to the housing 105 (e.g., as an external add-on piece).

Aiming assembly 155 is also be mounted in, attached to, or otherwise associated with the imaging device 100 and preferably includes an aiming light source, e.g., one or more aiming LEDs or laser light sources, and an aiming lens for generating and directing a visible aiming light beam away from the imaging device 100 onto an object. In some examples, the aiming assembly 155 and the imaging assembly 120 are combined within a single variable-focus scan engine.

A controller 175 is also positioned within housing 105 and is in communication with imaging assembly 120, depth sensor device 124, and aiming assembly 155. In various examples, controller 175 is configured to decode process signals from imaging assembly 120, e.g., from barcodes that are read by imaging assembly 120. The controller 175 is also configured to synchronize imaging assembly 120 and the depth sensor device 124 to determine the distance of an object from the imaging device 100 and in response set a focus position of the variable-focus imagining assembly for capturing subsequent images of the object. In particular, the controller 175 may be configured to detect, using the depth sensor device 124, a first detected distance of the object and perform, using the imaging assembly 120, a distance ranging procedure to detect a second detected distance of the object. The controller 175 may be configured to compare the first and second detected distances and, in response to a difference therebetween, perform a mitigation to determine a desired distance to the object.

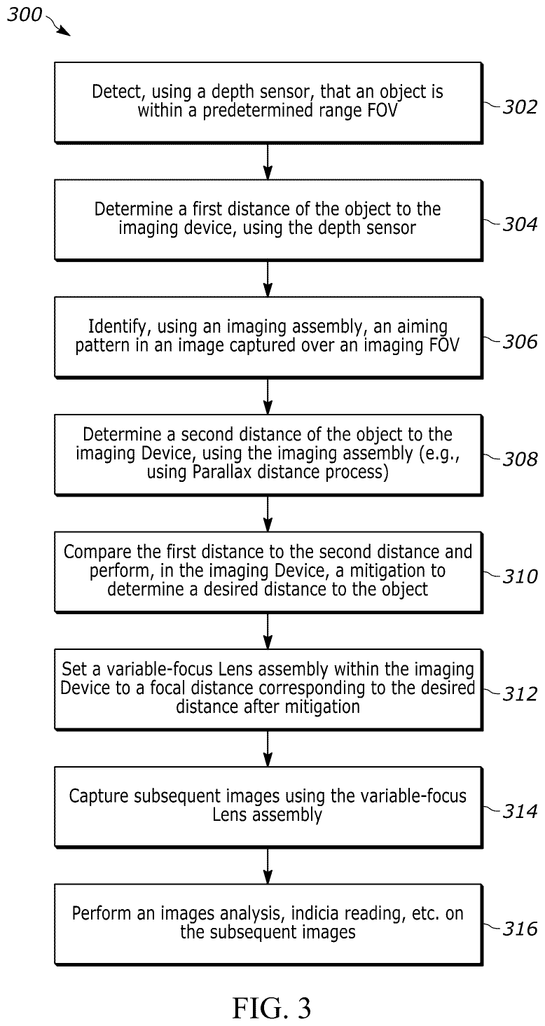

In various examples, the controller 175 is configured to synchronize operation of the two subsystems (i.e., the depth sensor device 124 and the imaging assembly 120) so that each subsystem captures images in tandem or other synchronized manner so that that the distances determined from each subsystem correspond to the same object and at the same general distance from the imaging device 100. However, the controller 175 may be configured to determine and compensate for certain differences in the distances, for example, where such distances are a result of the positioning of each subsystem of the imaging device 100. The controller 175 is further configured to determine, address, and mitigate for other differences in the distances measured by each subsystem, such as illustrated in the methods of FIGS. 3-5.

The controller 175 can be configured to activate the depth sensor device 124, the imaging assembly 120, the aiming assembly 175, and/or any other subsystems of the imaging device 100, simultaneously or in another synchronized manner. For example, the controller 175 may be configured to activate one of the depth sensor device 124 or the imaging assembly 120 initially and in response to detecting an object and/or determining a distance of the object, the controller 175 may active the other of the depth sensor device 124 and the imaging assembly 120.

As best shown in FIG. 1C, a horizontal viewing angle 129 of the depth (also termed ranging FOV herein) FOV 127 may be smaller than a horizontal viewing angle 130 of the imaging FOV 125 of imaging assembly. For example, the horizontal viewing angle 129 could be between 35 degrees and 55 degrees (e.g., a 45 degree×45 degree square FOV) and the horizontal viewing angle 130 of imaging FOV 125 could be between 40 degrees and 60 degrees.

In other examples, the horizontal viewing angle 129 of ranging FOV 127 may be wider than the horizontal viewing angle 130 of imaging FOV 125. In some such examples, the depth sensor device 124 may be used as a wake-up system, and the controller 175 can be configured to turn on the imaging assembly 120 when an object is detected in the ranging FOV 127 of depth sensor device 124. In other examples, including the configuration illustrated, the imaging assembly 120 may be used as the wake-up system first detecting the presence of an object in the imaging FOV 125. Such wake up may be desired when the imaging FOV 125 is larger than the ranging FOV 127. Although, such wake up may be desired whether the imaging FOV 125 is narrower or larger than the ranging FOV 127, for example when the imaging assembly 120 has a higher resolution than that of the depth sensor device 124. For example, the higher resolution may give the imaging assembly 120 an ability to detect objects over a greater distance from the imaging device 100 than that of the depth sensor device 124. Indeed, in various examples, as described, the depth sensor device 124 has a near field depth sensor capable of determining an object distance over a shorter distance than can be determined by the imaging assembly 120.

Referring next to FIG. 2A, a block diagram of an example architecture for an imaging device such as the imaging device 100 is shown. For at least some of the reader implementations, an imaging assembly 245 includes a light-detecting sensor or imager 241 operatively coupled to, or mounted on, a printed circuit board (PCB) 242 in the imaging device 200A as shown in FIG. 2A. In an example, the imager 241 is a solid-state device, for example, a CCD or a CMOS imager, having a one-dimensional array of addressable image sensors or pixels arranged in a single row, or a two-dimensional array of addressable image sensors or pixels arranged in mutually orthogonal rows and columns, and operative for detecting return light captured by an imaging assembly 245 over a field of view along an imaging axis 246 through the window 208. The imager 241 may also include and/or function as a monochrome sensor and, in further implementations, a color sensor. It should be understood that the terms “imager”, “imaging assembly”, “image sensor”, and “imaging sensor” are used interchangeably herein. Depending on the implementation, imager 241 may include a color sensor such as a vision camera in addition to and/or as an alternative to the monochrome sensor. In some implementations, the imager 241 is or includes the imaging assembly 120 (e.g., a monochromatic imaging sensor) of FIGS. 1A-1C. It will be understood that, although imager 241 is depicted in FIG. 2A as a single block, that imager 241 may be multiple sensors spread out in different locations of imaging device 200A.

The return light is scattered and/or reflected from an object 118 over the field of view. A variable-focus imaging lens 244, which in combination with the imager 241 forms a variable-focus imaging assembly, is operative for focusing the return light onto the array of image sensors to enable the object 118 to be imaged. The variable-focus imaging lens 244 has a focal distance that may be adjusted through electrical signal, mechanical adjustment, temperature adjustment, or other adjustment means, as controlled by controllers herein.

In operation, light that is collected by the variable-focus lens 244 is focused on the pixels of the imager 241, where light is sensed, and the output of those pixels produce image data that is associated with the environment that appears within the FOV (which can include the object 118). This image data is typically processed by a controller (usually by being sent to a decoder) which identifies and decodes decodable indicia captured in the image data. Once the decode is performed successfully, the reader can signal a successful “read” of the object 118 (e.g., a barcode). The object 118 may be located anywhere in a working range of imaging distances between a close-in working distance (WD1) and a far-out working distance (WD2). In an implementation, WD1 is about one-half inch from the window 208, and WD2 is about two hundred inches from the window 208. In various examples, WD2 may be from about 200 inches to about 1200 inches from the window 208.

In the illustrated example, the imaging assembly 245 further includes an illuminating light assembly that may also be mounted in, attached to, or associated with the imaging device 200A. The illuminating light assembly includes an illumination light source 251, such as at least one light emitting diode (LED) and at least one illumination lens 252, and preferably a plurality of illumination and illumination lenses, configured to generate a substantially uniform distributed illumination pattern of illumination light on and along the object 118 to be imaged by image capture. Although FIG. 2A illustrates a single illumination light source 251, it will be understood that the illumination light source 251 may include more light sources. At least part of the scattered and/or reflected return light is derived from the illumination pattern of light on and along the object 118.

In the illustrated example, the imaging assembly 245 further includes an aiming light assembly that may also be mounted in, attached to, or associated with the imaging device 200A and preferably includes an aiming light source 223, e.g., one or more aiming LEDs or laser light sources, and an aiming lens 224 for generating and directing a visible aiming light beam away from the imaging device 200A onto the object 118 in the direction of the FOV of the imager 241.

Parallax measurement may be used to determine a distance over the imaging range from WD1 to WD2. For example, the image 241 may identify an aiming pattern on the object 118 and determine a lateral distance of the position of that aiming pattern compared to a center of the image data such as the central axis 246. From the lateral distance, the imager 241 determines a lateral offset of the aiming pattern and from that lateral offset the imager 241 determines the distance of the object 118.

In the illustrated example, the imaging assembly 245 further includes a depth senor assembly 261 that may also be mounted in, attached to, or associated with the imaging device 200A and preferably is a TOF sensor that generates a ranging beam or pulse directed from the imaging device 200A onto the object 118 and receives reflection of that ranging beam or pulse and determines based on a time of flight of that process a distance of the object. In the illustrated example, the depth sensor assembly 261 is configured to determine the distance of the object 118 over ranging distances between a close-in working distance (WD3, coinciding with the WD1) and a far-out working distance (WD4). In an implementation, WD3 is about one-half inch from the window 208, and WD4 is about 30 inches or greater from the window 208. In various examples, a design feature is that WD2 is greater than WD4 in distance from the window 208.

The distance WD1 to WD2 is considered a (first) distance range of the imager 241 corresponding to the range over which the imager 241 can determine an object distance. The distance WD3 to WD4 is considered a (second) distance range of the depth sensor assembly 261 corresponding to the range over which the depth sensor assembly 261 can determine an object distance. As shown, at least a portion of the first distance range overlaps with a portion of the second distance range. In the illustrated example, the two distance ranges completely overlap with the second distance range within the first distance range. That need not be the case. In various examples, each of the two distance ranges may only partially overlap. Further still, the present techniques could be implemented in a manner in which the two distance ranges do not overlap, but are of a known spaced distance apart that a controller may nonetheless still perform a mitigation for detected differences between the two. As shown, in various examples, a depth sensor is operable to detect an object within a predetermined distance range from the imaging device, and an imaging sensor is operable to image that object over a range larger than the predetermined distance range.

In various examples, the depth sensor assembly 261 and/or the imaging assembly 120 may operate in a binned manner, where each respective distance range is separated into binned sub-regions. For example, binned sub-regions may represent distances of 0-6 inches, 6-20 inches, 20-50 inches, and 50+ inches, such that a distance measured from either the depth sensor assembly or imaging assembly may be represented as a ‘Bin 2 distance’ instead of a specific distance of 12 inches. In this way, the object distance value may be returned as corresponding to a particular binned sub-region. For example, where the depth sensor assembly 124 is operable to detect a first detected distance over a first plurality of binned distance ranges and where the imaging assembly 120 is operable to perform the distance ranging procedure over a second plurality of binned distance ranges, at least some of the first plurality of binned distance ranges overlap with the second plurality of binned distance ranges.

Further, the imager 241, the illumination source 251, the aiming source 223, and the depth sensor 261 are operatively connected to a controller or programmed microprocessor 258 operative for controlling the operation of these components. Depending on the implementation, the microprocessor 258 is the controller 175 as described above with regard to FIGS. 1A-1C. In some implementations, the microprocessor 258 functions as or is communicatively coupled to a vision application processor for receiving, processing, and/or analyzing the image data captured by the imagers.

A memory 270 is connected and accessible to the controller 258. Preferably, the microprocessor 258 is the same as the one used for processing the captured return light from the illuminated object 118 to obtain data related to the object 118. Though not shown, additional optical elements, such as collimators, lenses, apertures, compartment walls, etc. may be provided in the housing. Although FIG. 2A shows the imager 241, the illumination source 251, the aiming source 223, and the depth sensor 261 as being mounted on the same PCB 242, it should be understood that different implementations of the imaging device 200A may have these components each on a separate PCB, or in different combinations on separate PCBs. For example, in an implementation of the imaging device 200A, the illumination LED source is provided as an off-axis illumination (i.e., has a central illumination axis that is not parallel to the central FOV axis).

In some implementations, the object 118 is or includes an indicia for decoding (e.g., a decode indicia), such as a barcode, a QR code, a label, a UPC code, a digital matrix code, etc. In further implementations, the object 118 is or includes a digital watermark. The digital watermark may include a plurality of repeating barcodes, product codes, code patterns, or other such indicia that comprise the digital watermark. In some such implementations, the digital watermark is invisible or near-invisible to the human eye but is able to be detected and/or imaged by an imaging device 200A.

FIG. 2B is a simplified block diagram of a system 200B using the handheld imaging device 100 of FIG. 1 to project light toward an object 118, in accordance with implementations described herein. As noted above, the depth sensor device 124 of the handheld imaging device 100 may include the illumination light source 128 and one or more sensors 126.

In operation, to determine a ranging distance of the object 118, the imaging device 100 projects light 250 from the illumination light source 128 towards the object 118. In some implementations, the imaging device 100 projects the light 250 in response to an indication from a user, such as a trigger pull, button push, spoken command, etc. In further implementations, the handheld imaging device 100 projects the light 250 in response to an indication from a user via a computing device. In still further implementations, the imaging device 100 projects the light 250 in response to detecting or receiving an indication of an object 118, detecting an indication of a label, decoding data from a bar code or RFID tag associated with the object, etc.

In some implementations, the imaging device 100 includes a single illumination source 128, and therefore projects light according to the capabilities of the illumination source 128 (e.g., a particular color light, white light, UV light, etc.). In further implementations, the imaging device 100 includes multiple or variable illumination sources 128. In some such implementations, the imaging device 100 determines the wavelength of light to project based on an indication such as an input from a user to the handheld imaging device 100, an input from a user via a computing device, etc.

The projected light 250 travels at a speed v over a distance d from the device to the surface. In a vacuum, the speed v is the speed of light,

$$c \approx 299 , 792 , 458 \frac{m}{s} .$$

In air, the speed is slightly lower,

$$v = \frac{c}{n} ,$$

where n is the index of refraction for air, approximately 1.0003. In some implementations, the system 200 assumes that operations occur in air rather than a vacuum or other medium unless the handheld imaging device 100 receives an indication to the contrary (e.g., from the user). In further implementations, the projected light 250 has a duration f (which may vary with certain modulation schemes), and a travel time from the device to the surface of T_{I}.

Upon receiving the projected light 250 from the imaging device 100, the object 118 reflects at least some of the light as reflected light 260. In some implementations, because the time for the light to reflect is very short (e.g., on the order of 10⁻¹⁷ seconds), the handheld imaging device 100 treats the time to reflect as T_{B}≈0 for any calculations. The reflected light 260 returns from the object 118 to the imaging device 100. In particular, the reflected light 260 impacts with a sensor 126 of the imaging device 100. Depending on the implementation, the reflected light 260 may follow the same path or substantially the same path as the projected light 250, and thus the travel time T_{R}≈T_{I}.

In some implementations, the total time of travel (e.g., also referred to as time of flight (TOF)) is given by equation 1 as follows: T_{Tr}=T_{I}+T_{B}+T_{R}. The total time of travel may also be equal to the overall phase shift for the reflection of the light with measured illuminations Q₁, Q₂, Q₃, Q₄. As such, the total time of travel is also given by equation 2 as follows:

$${T}_{Tr} = \frac{ϕ}{2 π f} , where tan ( ϕ ) = \frac{{Q}_{3} - {Q}_{4}}{{Q}_{1} - {Q}_{2}} .$$

Since T_{I}≈T_{R} and T_{B}≈0,

$$\frac{arctan ( \frac{{Q}_{3} - {Q}_{4}}{{Q}_{1} - {Q}_{2}} )}{2 π f} \approx {T}_{R} + 0 + {T}_{R} .$$

As such, the time of travel for the reflected light is given by equation 3:

$${T}_{R} \approx \frac{arctan ( \frac{{Q}_{3} - {Q}_{4}}{{Q}_{1} - {Q}_{2}} )}{4 π f} ,$$

and the distance is given by equation 4:

$$d = vt = \frac{c}{n} \frac{arctan ( \frac{{Q}_{3} - {Q}_{4}}{{Q}_{1} - {Q}_{2}} )}{4 π f}$$

for the reflected light 260. This distance, being determined by a depth sensor is described herein as the ranging distance (or the depth distance), in comparison to the imaging distance determined by the imaging assembly 120, for example, through use of a parallax distance process. Thus, in various examples, the depth sensor device 124 is operable to detect the distance of the object 118 from the imaging device 100 when the object 118 is within a predetermined range (e.g., between WD1 to WD2) from the imaging device 100.

Depending on the implementation, timing relationships between certain components of the imaging device 100 such as the sensor assembly 126, the clock circuit, optics, processor 118, etc. may vary based on the temperature of the components, or timing aspects of system 100 may vary based on temperature. Such timing variations may cause inaccuracy in determining distances using the above calculations. These calculations may be adjusted by experimentally determining temperature adjustment factors that vary by temperature, determining an operational temperature for the system, and applying the temperature dependent temperature adjustment factors when calculating distance (or, for example TOF) by a ranging algorithm. The operational temperature may be measured by a temperature circuit of the handheld imaging device 100, a thermistor of an illumination device system, received by the handheld imaging device 100 via a networking interface, imaged by the sensor assembly from a visual indicator on an object label or thermometer, or via other means.

FIG. 2B further illustrates the aiming assembly 155 generating an aiming pattern 280, such as a dot, line, circle, cross, etc. that is emitted from the imaging device 100 and impinges upon the object 118. In response, the imaging assembly 120 captures image data 290 (images) of the object 118, more specifically images that include the aiming pattern 280.

That is, in various examples, the aimer assembly 155 is operable to generate an aiming pattern in an imaging FOV, and that causes the imaging assembly 120 to perform a distance ranging procedure to detect a distance of the object 118, when the object is within a predetermined range (e.g., WD3 to WD4). In particular, a parallax distance determination may be performed to determine an imaging distance to the object. For example, the imaging device 100 may be configured to identify the aiming pattern 280 in the captured image data and determine a lateral distance of the position of that aiming pattern compared to a center of the image data. From the lateral distance, the imaging device 100 determines a lateral offset of the aiming pattern and from that lateral offset the imaging device 100 determines the aiming pattern to the imaging device 100. In the illustrated example, that distance, d₁, is greater than the ranging distance, d₂, determined by the depth sensor device 124.

FIG. 2C illustrates features of the sensor assembly 126 of the depth sensor device 124 and an imager 131 of the imaging assembly 120, in an example. As shown, the sensor assembly 126 may be formed of a much smaller photodiode array than that of the imaging assembly 120. For example, a ratio of the size of a pixel array of the depth sensor assembly 126 to a pixel array of the imager may be 1 to 100 or greater. In some examples, that ratio is 1 to 200 or greater. The sensor assembly 126 may be formed of a 32×32 or 64×64 pixel array, for example, and the imager 131 may be a 2 megapixel array or a 4 megapixel array. As further shown, the sensor assembly 126 may have the pixels separated into multiple zones (four zones Z1, Z2, Z3, and Z4) such that the sensor assembly 126 is operable to detect a different distance of the object from the imaging device for each zone. In such examples, the sensor assembly 126 may be configured to detect a distance of the object from the imaging device, as an average of the different detected distances of the multiple zones or as a median of the different detected distances of the multiple zones.

FIG. 3 is an example method 300 illustrates a flow diagram of an example method for capturing and processing images of an object through determining the object distance to an imaging device and setting a variable-focus imaging assembly to capture subsequent images of that object. Although the method 300 is described with regard to imaging device 200A and components thereof as illustrated in FIG. 2A, it will be understood that other similarly suitable imaging devices and/or components may be used instead.

At block 302, the imaging device 200A detects, using a depth sensor (e.g., such as a time of flight (TOF) range sensor), that an object is within a predetermined range in a ranging FOV. In some implementations, the imaging device 200A begins capturing images responsive to detecting that the object is within the predetermined range. In some examples, the imaging device 200A captures images at a set frequency (e.g., capturing 60 images per second) from when the imaging device 200A detects the object within the range until a user attempts to trigger a decode event (e.g., by pulling a trigger). In further examples, the imaging device 200A captures images at a set frequency so long as the imaging device 200A continues to detect that the object is present within the predetermined range.

At a block 302, the imaging device 200A, using a depth sensor, determines the distance between the object and the imaging device 200A.

Depending on the implementation, the imaging device 200A may detect that an object is within the predetermined range when any of: a series of pixels (e.g., with resolution at 8×8, 32×32, 64×64, etc.) of an image stream are representative of the object within the predetermined range, a contiguous series of pixels of an image stream are representative of the object within the predetermined range, a predetermined number of pixels are determined to be present when a range threshold is met, etc. In examples where the depth sensor has multiple pixel zones, block 304 may determine the distance of an object as an average of different distances detected for of each of the multiple zones, or as a median of the different detected distances of the multiple zones. That is, in some examples, the distance to an object is determined by a depth sensor examining a center region of a ranging FOV, while in other examples, the distance is determined by looking over a plurality of portions of the ranging FOV.

At a block 306, the imaging device 200A, using the imaging assembly, captures one or more images over an imaging FOV and identifies an aiming pattern in those one or more images. That is, at the block 306, the imaging device 200A may instruct an aiming assembly to generate an aiming pattern over the imaging FOV.

At the block 308, responsive to identifying an aiming pattern in the one or more images, the imaging device 200A determines a distance of the object using the imaging assembly. For example, the block 308 may perform a parallax distance process that analyzes the distance of that aiming pattern from the center of an imaging FOV from which the object distance is determined.

At a block 310, the imaging device 200A compares the object distances from the blocks 304 and 308 and then performs a mitigation to determine a desired distance to the object, i.e., from the imaging device 200A. The mitigation may be performed when there is discordance between the two distance values. The mitigation may then set a desired distance based an algorithm comparison of that discordance.

With the desired distance determined, a block 312 sets a variable-focus lens assembly of the imaging device 200A to a focal distance corresponding to that desired distance determined by the block 310, after the mitigation. Thus, the imaging device 200A is then configured to captured subsequent images of the object at block 314 where the subsequent images are in focus such that at a block 316, the imaging device 200A can perform image analysis, indicia reading and decoding, and/or other features on the subsequently captured images.

It is noted that the blocks 304 and 308 can be configured to determine the distance of an object by examining desired portions of the respective FOVs or respective pixel arrays. An imager may consider only the center of the respective FOV in determining the distance. An imager may consider a range of pixels surrounding the center of the FOV (e.g., according to a parallax offset for the imager compared to other imagers in the imaging device). In still further examples, an imager may identify a region of contiguous pixels surrounding the center of the depth FOV for calculating the distance of the object 118. Similarly, the imaging device may perform a calibration, for one or both the depth sensor device and imaging assembly, upon startup and/or upon manufacture to determine where to consider for determining the distance between the imaging device and an object.

In some examples, the imaging device 200A automatically captures images and/or a stream prior to the object entering the predetermined range and only begins storing the images after the object 118 enters the predetermined range. For example, the imaging device 200A may include a cradle, charging station, holding station, etc. Upon a user removing the imaging device 200A from the cradle, the imaging device 200A may automatically begin streaming and/or capturing images. In some examples, the imaging device 200A stores one or more of the captured images in a buffer storage prior to a user initiating a trigger event to decode the indicia (e.g., pulling a physical trigger, pushing a button, inputting a command, etc.). In some such examples, the imaging device 200A uses one or more of the images stored in the buffer storage at blocks 304 and/or 306 for additional image processing (e.g., for an object identification image process) and/or decoding an indicia as described in more detail below. Depending on the implementation, the captured images may have a pixel resolution of 32×32, 64×64, 128×128, etc.

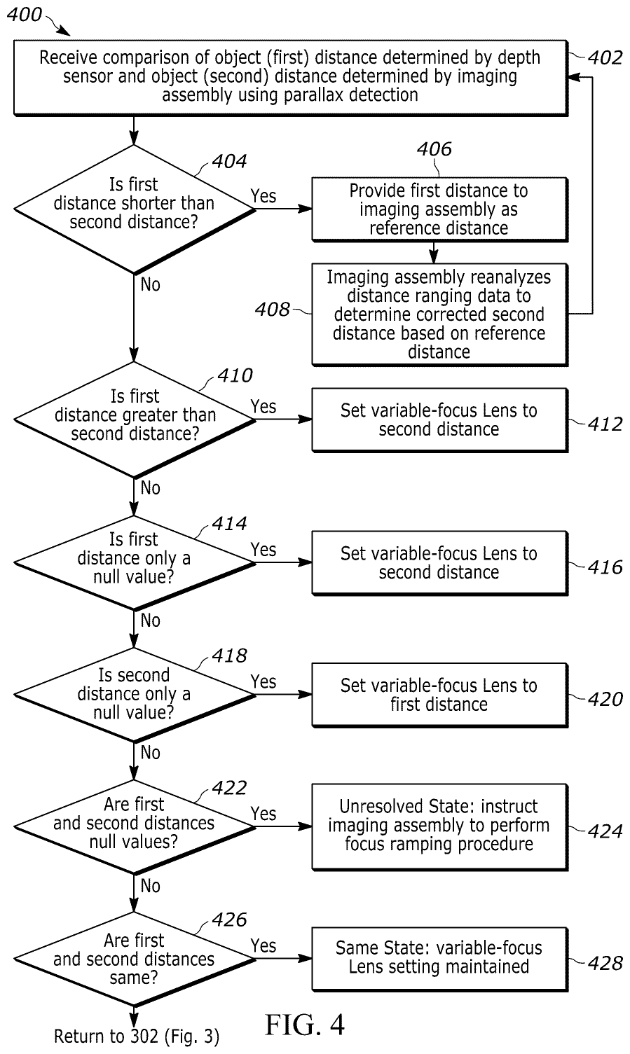

FIG. 4 illustrates a method 400 for performing a mitigation as may be performed by block 310 in FIG. 3, that is, in response to comparing the first and second distances from blocks 304 and 308, respectively.

In the illustrated example, the process 400 starts with block 402 receiving the comparison between a first distance determined by the depth sensor device and a second distance determined by the imaging assembly using a parallax detection (or other ranging detection). For example, such a comparison can be received at block 310 of process 400. From that comparison a series of different mitigations can be performed depending on the discordance between the two distance values. A series of six (6) different mitigations are illustrated and in a particular order. It will be appreciated that the imaging devices herein may be configured with fewer or greater numbers of mitigations. Further, the mitigations are illustrated in an example order. However, the mitigations may be implemented in different orders.

In the illustrated example, at a block 404, the imaging device 200A implements a first mitigation that results in determining a subsequent distance value for comparison by the process 400, or by the process 300. The block 404 determines whether the first distance (i.e., determined by a depth sensor, such as the TOF sensor 261) is shorter than the second distance (i.e., determined by the imaging assembly 120 using a parallax detection of the aiming pattern). If that condition is met, the process 400 attempts to re-determine the second distance. For example, the process 400 passes control to a block 406 where the first distance (i.e., determined by the depth sensor assembly) is obtained to serve as a reference distance. Next, a block 408 reanalyzes the ranging data from the imaging assembly used to determine the second distance. For example, an aiming pattern measured to determine the second distance may have been split between a near object and a far object. The parallax detection of the imaging assembly 120 may have favored the aiming pattern on the far object when determining the second distance, while the depth sensor assembly may have only picked up on the larger near object. The block 408 may then re-examine the distance ranging data using the first distance data. If an aiming pattern appears in two locations in captured image data, the block 408 may determine whether one of those two locations is a corrected second distance that corresponds with the first distance, which would indicate agreement between the two assemblies. Thus, an example mitigation provides that by re-analyzing parallax detection data using the output of a depth sensor, an imaging device we can examine whether an aiming pattern is at a location that equates to a distance that agrees with the distance generated by a depth sensor. In yet other examples, the mitigation from the condition of block 404 being satisfied could result in the capture of a subsequent image using the imaging assembly, by first adjusting the variable-focus lens of the imaging assembly (e.g., variable-focus lens 244) to a new focal point based on the first distance, and then capturing a subsequent image over the imaging FOV using that new focal point. In some such examples, the process after block 404 would determine an updated object distance, i.e., an updated second distance, and return control back to block 402 for a comparison of the first distance to the newly obtained second distance.

The imaging device 200A implements a second mitigation using a block 410 that determines if the first distance is greater than the second distance. If that condition is met, at a block 412, the process 400 sets the variable-focus lens of the imaging assembly (e.g., variable-focus lens 243 of the imager 241) to the second distance, after which images may be captured for scanning an indicia decoding, image analysis, machine vision applications, or other operations of imaging devices herein.

The imaging device 200A implements a third mitigation using a block 414 that determines if the depth sensor device fails to determine a first distance, e.g., if a null value is returned. Such a state may occur, for example, when an object is outside of a predetermined operable distance range of the depth sensor device, e.g., when the object is outside of the range between and including WD3 and WD4. If the condition is met, a block 416 sets the variable-focus lens of the imaging assembly (e.g., variable-focus lens 243 of the imager 241) to the second distance.

The imaging device 200A implements a fourth mitigation using a block 418 that determines if the imaging assembly fails to determine a second distance, e.g., if a null value is returned. Such a state may occur, for example, when an object is outside of a predetermined operable distance range of the imaging assembly, e.g., when the object is outside of the range between and including WD1 and WD2. If the condition is met, a block 420 sets the variable-focus lens of the imaging assembly (e.g., variable-focus lens 243 of the imager 241) to the first distance.

The imaging device 200A implements a fifth mitigation using a block 422 that determines if both the depth sensor device and the imaging assembly fail to determine respective distances. If that condition is met, a block 424 identifies an unresolved state of the imaging device 200A, and the block 424 instructs the imaging device 200A to perform a focus ramping procedure to determine the distance of the object for scanning an indicia or performing other operations of the image device 200A.

The imaging device 200A implements a sixth mitigation using a block 426 that determines if the first and second distances are the same. Such same state condition indicates that the variable-focus lens is already set to a suitable focal point and therefore its setting is maintained.

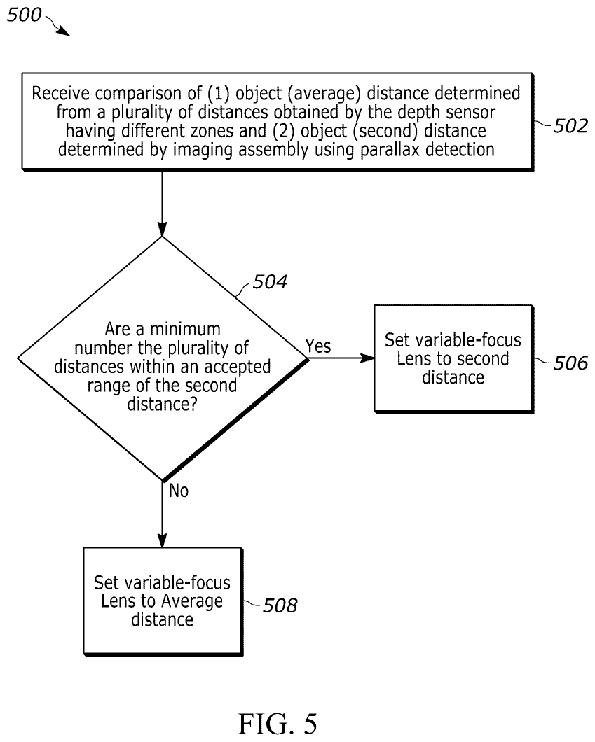

FIG. 5 illustrates a method 500 for performing a mitigation as may be performed by block 310 in FIG. 3, that is, in response to comparing the first and second distances from blocks 304 and 308, respectively. The process 500 differs from the process 400, in that the former may be performed in response to one of the distances being an average distance determined from a plurality of distances, instead of using a single first distance and single second distance. While the process 500 is described as based on an average it will be appreciated that the computed distance may be a median value or other distance value statistically determined from a plurality of distances. In the illustrated example, the process 500 starts with block 502 receiving the comparison between an average distance determined from a plurality of distances obtained from a depth sensor device and a second distance determined by the imaging assembly using a parallax detection (or other ranging detection). That is, the average distance may be determined as described above for example where the depth sensor contains multiple zones, and each zone determines a distance to an object.

At a block 504, the process 500 determines if a minimum number of the plurality of distances are within an accepted range of the second distance. For example, with a depth sensor having four zones, if one or two distances determined by the depth sensor are within a predetermined range of the distance determined by the imaging device, the condition for block 504 is met. The minimum number of distances from the depth sensor can be set to any suitable value depending upon the size of the depth sensor and the number of distances that are used to calculate the average distance. In one mitigation, if the condition at block 504 is met, at a block 506, the process 500 sets the variable-focus lens of the imaging assembly (e.g., variable-focus lens 243 of the imager 241) to the second distance. In another mitigation, if the condition at block 504 is not met, a block 508 sets the variable-focus lens to the average distance. After block 506 or block 508 is executed, and scanning an indicia or other operations of the image device 200A may then be performed.

It will be appreciated that other operations may be performed in addition to those described in the example processes 300, 400, and 500. For example, imaging devices may determine not to perform an indicia decode event if a predetermined length of time passes between an object entering a ranging FOV or an imaging FOV and none of the mitigations described herein have been completed. In another example, the imaging device 200A may determine not to perform an indicia decode event if the object exits one or both of the ranging FOV and the imaging FOV without completion of a mitigation or if a predetermined length of time passes.

Further depending on the implementation, the imaging device 200A may alert a user, an employee, or another individual associated with the imaging device 200A responsive to completion of a mitigation and/or responsive to a failure to complete any mitigation. For example, when the imaging device 200A fails to perform a mitigation, the imaging device 200A may further determine that the individual scanning objects is attempting a sweethearting, a scan avoidance, and/or is otherwise preventing operation of the imaging device 200A. As such, the imaging device 200A may generate an alert (e.g., a textual alert, an auditory alert, a visual alert, etc.) that may be sent or presented to a manager or employee. That alert may be presented on the imaging device, such as on a handheld barcode reader.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An imaging device for capturing and processing images, the imaging device comprising:
a housing;
a depth sensor operable to detect that an object is in a ranging field of view (FOV) of the depth sensor;
an imaging sensor at least partially disposed within the housing and operable to capture images of the object within an imaging FOV of the imaging sensor;
one or more processors; and
a computer-readable media storing machine readable instructions that, when executed, cause the one or more processors to:
detect, using the depth sensor, a first detected distance of the object from the imaging device;
perform, using the imaging sensor, a distance ranging procedure to detect a second detected distance of the object from the imaging device;
compare the first detected distance to the second detected distance; and
in response to a difference between the first detected distance and the second detected distance perform a mitigation to determine a desired distance to the object.

2. The imaging device of claim 1, wherein the depth sensor is a time of flight (TOF) sensor.

3. The imaging device of claim 1, the imaging device further comprising:
an aimer assembly operable to generate an aiming pattern in the imaging FOV; and
wherein the computer-readable media stores machine readable instructions that, when executed, cause the one or more processors to:
perform, using the imaging sensor, the distance ranging procedure to detect the second detected distance by performing an aiming pattern parallax detection in the imaging FOV.

4. The imaging device of claim 1, wherein the depth sensor is operable to detect the object within a predetermined distance range from the imaging device, wherein the imaging sensor is operable to image the object over a range larger than the predetermined distance range.

5. The imaging device of claim 1, wherein the computer-readable media stores machine readable instructions that, when executed, cause the one or more processors to:
detect, using the depth sensor, the first detected distance of the object from the imaging device when the object is within a predetermined range from the imaging device; and
perform, using the imaging sensor, the distance ranging procedure over a range larger than the predetermined distance range.

6. The imaging device of claim 1, wherein the mitigation comprises:
(i) in response to the first detected distance being shorter than the second detected distance, perform the distance ranging procedure again using the first detected distance as a reference to detect a corrected second detected distance; and
(ii) in response to the first detected distance being further than the second detected distance, set the desired distance to the object as the second detected distance.

7. The imaging device of claim 1, wherein the depth sensor comprises multiple zones and is operable to detect a different first detected distance of the object from the imaging device for each zone.

8. The imaging device of claim 7, wherein the computer-readable media stores machine readable instructions that, when executed, cause the one or more processors to:
detect, using the depth sensor, the first detected distance of the object from the imaging device as an average of the different first detected distances of the multiple zones or a median of the different first detected distances of the multiple zones.

9. The imaging device of claim 8, wherein the mitigation comprises:
(i) in response to the first detected distance being further than the second detected distance, determine if a minimum of the different first detected distances is within an accepted range of the second detected distance; and
(ii) if the minimum of the different first detected distances is within the accepted range of the second detected distance, set the desired distance to the object as the second detected distance otherwise set the desired distance to the object as the average of the different first detected distances of the multiple zones.

10. The imaging device of claim 1, wherein the computer-readable media stores machine readable instructions that, when executed, cause the one or more processors to:
in response to the depth sensor failing to detect the first detected distance of the object, set the desired distance to the object as the second detected distance.

11. The imaging device of claim 1, wherein the computer-readable media stores machine readable instructions that, when executed, cause the one or more processors to:
in response to the imaging sensor failing to detect the second detected distance of the object, set the desired distance to the object as the first detected distance.

12. The imaging device of claim 1, wherein the computer-readable media stores machine readable instructions that, when executed, cause the one or more processors to:
in response to (i) the imaging sensor failing to detect the second detected distance of the object and (ii) the depth sensor failing to detect the first detected distance of the object, instructing the imaging sensor to perform a focus ramping procedure.

13. The imaging device of claim 1, wherein a ratio of a size of a pixel array of the depth sensor to a pixel array of the imaging sensor is 1 to 100 or greater.

14. The imaging device of claim 13, wherein the ratio of the size of the pixel array of the depth sensor to the pixel array of the imaging sensor is 1 to 200 or greater.

15. The imaging device of claim 1, wherein the depth sensor is operable to detect the first detected distance over a first plurality of binned distance ranges and wherein the imaging sensor is operable to performing the distance ranging procedure over a second plurality of binned distance ranges, wherein at least some of the first plurality of binned distance ranges overlap with the second plurality of binned distance ranges.

16. A method for capturing and processing images using an imaging device, the method comprising:
detecting, using a depth sensor of the imaging device, a first detected distance of an object within a ranging field of view (FOV), the first detected distance being between the object and the imaging device;
generating, using an aiming assembly, an aiming pattern in an imaging FOV of an imaging sensor;
performing, using the imaging sensor, a distance ranging procedure analyzing the aiming pattern in the imaging FOV and detecting a second detected distance of the object from the imaging device;
comparing the first detected distance to the second detected distance and in response to a difference between the first detected distance and the second detected distance performing a mitigation to determine a desired distance to the object; and
adjusting a variable-focus lens assembly of the imaging device to a focal distance based on the desired distance.

17. The method of claim 16, wherein the depth sensor is a time of flight (TOF) sensor, and wherein the distance ranging procedure is an aiming pattern parallax detection procedure.

18. The method of claim 16, wherein detecting the first detected distance of the object within the ranging field of view (FOV) is performed over a predetermined depth sensor distance range, wherein detecting second detected distance of the object from the imaging device is performed over a predetermined imaging sensor distance range, wherein the predetermined imaging sensor distance range is larger than the predetermined depth sensor distance range.

19. The method of claim 16, wherein performing the mitigation comprises:
in response to the first detected distance being shorter than the second detected distance, performing the distance ranging procedure again using the first detected distance as a reference to detect a corrected second detected distance; and
in response to the first detected distance being further than the second detected distance, setting the desired distance to the object as the second detected distance.

20. The method of claim 16, wherein the depth sensor comprises multiple zones and is operable to detect a different first detected distance of the object from the imaging device for each zone, wherein detecting the first detected distance of the object comprises:
setting the first detected distance of the object from the imaging device as an average of different first detected distances of the multiple zones or as a median of the different first detected distances of the multiple zones.

21. The method of claim 20, wherein performing the mitigation comprises:
in response to the first detected distance being further than the second detected distance, determining if a minimum number of the different first detected distances is within an accepted range of the second detected distance; and
if the minimum number of the different first detected distances is within the accepted range of the second detected distance, setting the desired distance to the object as the second detected distance otherwise setting the desired distance to the object as the average of the different first detected distances of the multiple zones.

22. The method of claim 20, wherein performing the mitigation comprises:
in response to the depth sensor failing to detect the first detected distance of the object, setting the desired distance to the object as the second detected distance.

23. The method of claim 20, wherein performing the mitigation comprises:
in response to the imaging sensor failing to detect the second detected distance of the object, setting the desired distance to the object as the first detected distance.

24. The method of claim 20, wherein performing the mitigation comprises:
in response to (i) the imaging sensor failing to detect the second detected distance of the object and (ii) the depth sensor failing to detect the first detected distance of the object, instructing the imaging sensor to perform a focus ramping procedure.
